(19) United States
(12) Patent Application Publication
(10) Pub. No.: US 2010/0259045 A1
(43) Pub. Date: Oct. 14, 2010

(54) Wing Energy Installation with Enhanced Overvoltage Protection

(75) Inventor: Reinhard Vilbrrandt, Rostock (DE)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: SUZLON ENERGY GMBH, ROSTOCK (DE)

(21) Appl. No.: 12/682,940

(22) PCT Filed: Oct. 14, 2008
(86) PCT No.: PCT/EP2008/063774

§ 371 Date: Jun. 25, 2010

(30) Foreign Application Priority Data
Oct. 15, 2007 (DE) 10 2007 049 592.9

(51) Int. Cl. H02P 9/04

(52) U.S. Cl. 290/44

(57) ABSTRACT

A wind energy installation and method for production of electrical energy from wind energy by means of the wind energy installation having a rotor which can be driven via wind power and has rotor blades whose pitch angles can be adjusted by means of at least one adjusting apparatus, which can be driven electrically, in order to influence the rotational speed of the rotor, wherein a generator rotor is connected to the rotor, and the generator rotor together with the stator forms a generator,

and wherein a magnetic field which rotates with respect to the generator rotor is produced by the stator and, by interaction with the generator rotor, which is stationary with respect to the pod, induces a current flow in the generator in order to operate the adjusting apparatus.

The invention relates to wind energy installations with a rotor which is rotatably supported on a pod, which comprises a hub, wherein the rotor comprises at least one electrically driven adjusting apparatus for adjusting the pitch angle of at least one rotor blade which is affixable or affixed to the hub, and which is connected to a generator rotor which together with a stator forms a generator for supplying power to the adjusting apparatus. The present invention also relates to a method for generating electric energy with the wind energy installations according to the invention.

Usually, an individual adjustment drive is provided for each rotor blade in a wind energy installation. In cases of emergency, when components or the power supply fail, an emergency operation device is usually provided in order to adjust the rotor blades to a fail-safe position (e.g. flag position). The emergency power is provided electrically, hydraulically or mechanically.

Sensor signals and control signals are transmitted via wires from the pod to the hub and vice-versa. Due to the rotatable hub, all signals must be guided over slip rings. Slip rings are also used for the electrical energy transfer into the hub. Hydraulic energy is transferred via a rotary feedthrough into the rotor shaft, or the hydraulic blade adjustment is located entirely in the hub, in which case the electrical energy required is also transferred via slip rings.

Due to the cable connections for the pod and the hub, potential overvoltages caused by lightning strikes or malfunctions can be transferred from the pod into the hub. Lightning strikes in the rotor blades are deflected into the ground via the hub, the pod and the tower. Due to the galvanic connection of components in the hub and with the hub, it cannot be precluded that deflections occur via these components and assemblies. In particular however, the safety-relevant blade adjustment module may not under any circumstances fail completely, since otherwise, overpressure, damage and even destruction of the wind energy installation may occur.

A standard electrical pitch drive is described in DE 103 35 575 B4. The blade adjustment is based on three-phase motors and frequency converters (servo controller). The frequency converters are fed by three-phase current and provide a direct current interim circuit by means of rectifiers. From this circuit, inverters are then fed in order to control the three-phase motors. For an emergency supply, an electric energy storage device is usually provided, which feeds the interim circuit. The energy storage device can be realised by means of rechargeable batteries or capacitors.

It is known from DE 10 2004 005 169 B3 that DC current motors can be used to adjust the blades.

As well as electrical systems for blade adjustment, hydraulic systems e.g. from DE 101 46 986 A1, are also known. The system consists of a hydropump with electric pump drive, a pressure accumulator, a control arrangement and a hydrocylinder. As a result of appropriate control via the control arrangement and the supply of pressurising agent from the hydrocylinder, the pitch angle of the rotor blades is adjusted.

In DE 200 17 994 U1, a combination of electrical individual blade adjustment and a hydraulic emergency adjustment with hydraulic emergency energy supply is described.

From DE 10 2004 024 563 A1, DE 100 09 472 C2, DE 200 20 232 U1 and DE 196 44 705 A1, the use of auxiliary generators on the shaft side is known in order to provided auxiliary energy in the hub. Usually, the auxiliary generator is attached in the rotor shaft in such a manner that its rotor has a rotary field winding, and the shaft is integrated, and the stator is constructed in a stationary manner from permanent magnets or excitation windings. Advantageously, the outer stator can also be rotatably arranged, in order to vary the relative rotational speed between the rotor and the stator (permanent magnet) and thus be able to alter the electrical capacity. The electrical capacity can also be set by means of an appropriate control of the excitation voltage and frequency in excitation windings.

The disadvantage of this solution is that the auxiliary generators on the shaft side are used solely in order to supply emergency power and for the flag position of the rotor blades.

A slip ring for the wired transfer of electrical energy between two mutually rotatable systems for application in a wind power plant is described in DE 297 05 011 U1.

Lightning protection devices for wind power plants are known from DE 44 45 899 A1, DE 44 36 197 C2 and DE 195 01 267 A1. The protection function exists in the canalised deflection of currents resulting from overvoltages.

The object of the present invention is to improve a wind energy installation and a method for generating electrical energy with the wind energy installation in such a manner that the probability of damage to the blade adjustment system in the hub as a result of overvoltages from the pod or from the effect of lightning over the blades is significantly reduced.

This object is attained by the wind energy installation according to the invention described in claim 1, and by means of the method for generating electrical energy from wind energy according to the invention described in claim 10.

Advantageous embodiments of the device according to the invention and the method according to the invention follow in the respective subclaims 2 to 9 and 11 to 15.

According to the invention, a wind energy installation with a rotor which is rotatably supported on a pod is provided, which comprises a hub, wherein the rotor comprises at least one electrically driven adjusting apparatus for adjusting the pitch angle of at least one rotor blade which is affixable or affixed to the hub, and which is connected to a generator rotor which together with a stator forms a generator for supplying power to the adjusting apparatus. According to the invention, the stator is installed and designed in such a manner that through it, a rotating magnetic field can be generated with respect to the generator rotor which is at a standstill with respect to the pod. This means that the rotor comprises a hub which is designed as an extra machine element, which is firmly connected to the rotor. The rotor is here connected to a generator rotor which incorporates the structural embodiment of a fixed connection between the rotor and the generator rotor, or also comprises the embodiment in which the generator rotor is an integral part of the rotor. An essential feature of the connection between the rotor and the generator rotor is that the generator rotor is essentially arranged on the rotor in such a manner that it cannot rotate. The generator rotor and the stator together form the auxiliary generator, i.e. the stator described here does not serve as a counterpiece to the rotor of the wind energy installation in order to generate the energy to be fed to the power grid, but simply to generate energy to operate the adjusting apparatus and if appropriate, further auxiliary devices on the rotor. The generator rotor of the auxiliary generator is electrically connected to the adjusting apparatus. This is preferably an electrically driven adjusting apparatus, wherein it can e.g. comprise an electric motor, or also an electrically drive pump e.g. for a hydraulic motor.

In the embodiment variant in which the rotor of the wind energy installation comprises only one adjusting apparatus for adjusting several rotor blades, the rotor comprises gears in order to move the blades. In order to generate power with the auxiliary generator, which is created by the generator rotor and the stator, the stator is connected to the energy source in order to generate the rotating energy field. The power supply to the adjusting apparatus is thus galvanically separated from the pod, so that an overvoltage protection e.g. during a lightning strike, is guaranteed.

As a result of the device according to the invention, it is possible to realise that in particular with a stationary generator rotor, e.g. with weak wind conditions or a flag position of the rotor blades, the rotating magnetic field of the stator induces a current flow in the generator rotor which can be used to operate the adjusting apparatus. Thus when the rotor is stationary, the pitch angle of the rotor blades can be changed in order to thus subject these to the wind forces, and to induce a wind-generated torque in the rotor. Due to the embodiment according to the invention, it is not precluded that with the stator, a rotating magnetic field can be produced with respect to a generator rotor which rotates relative to the pod, either effected by a rotation of the magnetic field by the stator, or effected with the stationary stator magnetic field by a relative rotation of the generator rotor in relation to the stator. With a rotating rotor, it is preferably provided that the stator and if appropriate, permanent magnets provided on it, are stationary with respect to the pod, and current is induced in the auxiliary generator by the relative movement between the generator rotor and the stator. These variants of the auxiliary generator drive should in particular be applied when e.g. the rotor pitch angle should be reduced when the wind is too strong.

Two variants according to the invention have been developed in order to form the rotatable magnetic field generated by the stator. In a first embodiment, the rotating magnetic field can be realised with lines through which current can flow in the form of windings on the stator, wherein the lines are arranged in such a manner that when a current in the form of an alternating or three-phase current is applied, they generate a rotating magnetic field.

In a second embodiment, it is provided that the rotating magnetic field can be realised by means of at least one rotatably arranged, motor driven permanent magnet. The permanent magnet can here be rotatably arranged on the stator, or it can be provided that the stator which comprises the permanent magnet is itself rotatably supported.

Advantageously, the stator should here be designed in such a manner that the rotational speed of the rotating magnetic field can be adjusted.

This can be realised by applying an alternating or three-phase current by means of a frequency regulator.

With the embodiment with rotating permanent magnets, the rotational speed can be adjusted by means of a control unit to influence the rotational speed of the drive motor in order to drive the permanent magnet.

The present invention is particularly suited to attaining the object when the wind energy installation comprises a device for protecting the lines against overvoltage, and a galvanic separation of the current-bearing parts of the adjusting apparatus is implemented with respect to the rotor.

Advantageously, the wind energy installation comprises a central control device which is not arranged on the rotor, wherein the adjusting apparatus is installed for receiving and processing wireless transmitted signals, and the wind energy installation comprises at least one signal transmission unit for the wireless transmission of signals from the central control system to the adjusting apparatus. For this purpose, radio interfaces should be arranged on the central control system and the adjusting apparatus.

In order to avoid damage caused by overvoltage, it is appropriate to design the hub as a Faraday cage.

In order to guarantee energy self-sufficiency, the wind energy installation can in an advantageous embodiment comprise an emergency energy supply device in the pod and/or the hub.

According to the invention, a method is furthermore provided for generating electrical energy from wind energy by means of a wind energy installation with a rotor with rotor blades, the pitch angles of which can be adjusted with at least electrically drivable adjusting apparatus in order to influence the rotational speed of the rotor, wherein a generator rotor is connected to the rotor and the generator rotor forms a generator together with the stator. According to the invention, a rotating magnetic field with respect to the generator rotor is generated which in interaction with the generator rotor which is stationary with respect to the pod induces a current flow generator rotor for activating the adjusting apparatus. This means that the method is conducted during the operation of the wind energy installation in order to generate power, wherein with the aid of the adjusting apparatus, the pitch angles of the rotor blades change. The method according to the invention described can be conducted with the device according to the invention presented here. The method relates in particular to the energy supply of the adjusting apparatus with a rotor which is stationary with respect to the pod, wherein the situation intended here is one in which no rotation of the rotor occurs, and not a structural design which precludes a rotation of the rotor with respect to the pod. Here, the rotating magnetic field can be realised by applying alternating or three-phase current to lines in the form of windings on the stator. Alternatively, the rotating magnetic field can be realised by at least one rotatably arranged, motor driven permanent magnet.

In order to influence the current generated by the rotating magnetic field, or the electrical energy generated by it, the rotational speed of the rotating magnetic field is changed during the revolution.

Advantageously, signals for actuating the adjusting apparatus are transmitted to said device in a wireless manner, in order to guarantee a complete galvanic separation between rotor and pod. The method according to the invention is in particular designed in an advantageous manner in that the rotating magnetic field is generated when the rotor is stationary in order to induce current for actuating the adjusting apparatus. Thus, in particular with a pitch angle of 0° of the rotor blades (flag position of the rotor blades), for the purpose of bringing the rotor, and thus the generator rotor to a stationary position, the blades are set at an angle by means of the adjusting apparatus when a return to operation of the wind energy installation is required. For this purpose, the adjusting apparatus must be supplied with energy, for which reason the rotating magnetic field generated by the stator can induce a current in the generator rotor itself when the generator rotor is stationary.

According to the invention, the entire communication between the fixed area of the wind energy installation (tower and pod) and the rotatable area (hub) should be achieved via suitable wireless transmission channels. For this purpose, transmission and receiving units are provided in the hub and the pod and/or tower.

For example, wireless connections can be realised via known systems such as Bluetooth (IEEE 802.15.1), WLAN (IEEE 802.11), ZigBee (IEEE 802.15.4) or Wireless FireWire (IEEE 802.15.3). Equally, radio standards can be used which will only be disclosed in future. It would also be possible to design a separate radio interface, although the cost has been estimated as being too high. Digital radio interfaces are preferable due to the lower proneness to failure and improved potential implementation in the control and sensor systems, although an analogue radio connection is also feasible. Alternatively, other methods for the wireless transmission of data, such as an infrared interface, can also be used.

A suitable realisation form provides for a microcontroller for the individual blade adjustment systems and control of the wind energy installation. Instead of microcontrollers, adequate control devices based on SPS, computer technology or other systems can be used. The control centre and the distributed blade adjustment systems have radio interfaces for communication. Here, each blade adjustment should be able to communicate at least with the central control system.

In further designs, a central radio interface is also feasible for all blade adjustment systems, as is communication between the blade adjustment systems via the radio interfaces.

Environment sensors (temperature, air pressure, humidity etc.), sensors for blade adjustment (angle position, adjustment speed) and sensors for general operation (rotor speed) and other sensors which are not listed, can be attached directly in the hub. These sensors or sensor groups have either their own radio interfaces, or in a preferred embodiment, they are connected to the control system of a respective blade system, and are thus accessible via its radio interface for the central control system and other blade adjustment systems.

The control specifications and status reports are transmitted between the central control system and the blade adjustment systems via the bi-directional radio interface.

In general, antennae are used for the radio transmission of signals. These should be selected in such a manner that the transmission of the signals can occur without, or only with low, interference. The antennae are attached either inside the pod and the hub, or in a further design, via cable extensions to the outer side of the pod and the hub. In this manner, shielding which can interfere with radio waves, in particular on the hub, can be avoided.

As an alternative embodiment, the wireless data transmission between the central control system and the hub is conducted optically. For this purpose, infrared interfaces are arranged, for example.

The emergency energy supply for cases when the voltage fails, or when another serious fault occurs, is installed in the pod or the hub.

The emergency energy supply can furthermore maintain a rotating magnetic field, e.g. via the excitation windings on the auxiliary generators, and thus guarantee the supply of electric power in the hub. It is equally possible to arrange an electrical emergency energy supply in the hub. The separate supply of the individual blade adjustment systems is then advantageous for the greatest possible operational safety. In a further design, emergency energy supply systems can also be provided in the pod and the hub for a redundant implementation.

The hub is designed as a Faraday cage. The metal nub is designed as a sphere to the greatest extent possible. Socket openings for the blade attachment and maintenance access are closed by means of suitable grid or metal sheet structures in order to complete the cage. All components in the hub are galvanically insulated to the hub and are thus attached to the Faraday cage. Thus, the risk of a deflection of overvoltages caused by lightning or error over safety-relevant components of the blade adjustment can be avoided. For the required high creep resistance, the protective insulation is implemented by suitable attachment materials in connection with insulation sections or clearances.

Due to the features according to the invention, the availability of the blade adjustment, and thus the overall safety of the plant, is increased. Additionally, due to the systematic potential separation between the pod and the hub, any possible ground potential displacement in the hub, and thus a potential error source, is avoided.

The invention will now be explained in greater detail with reference to the following drawing.

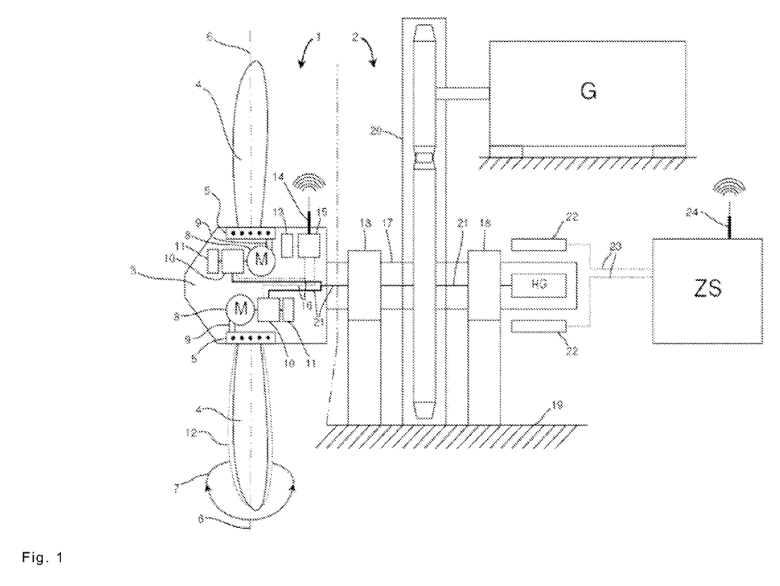

FIG. 1 shows operational sections of the pod and rotor of a wind energy installation according to the invention. It is to be understood as a realisation option among different designs and embodiments.

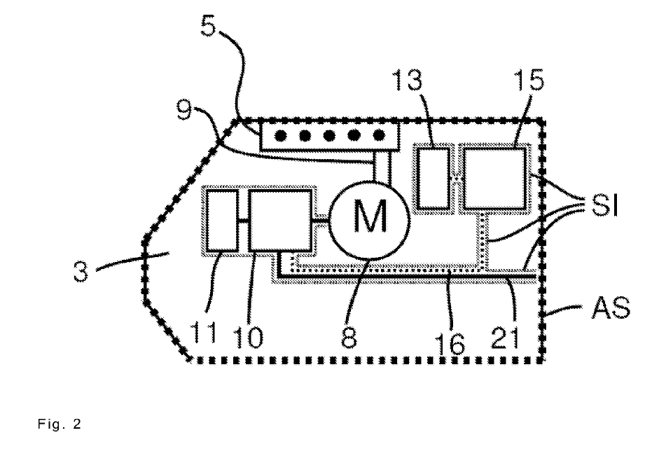

FIG. 2 shows the hub structure according to the invention as a Faraday cage with the additionally insulated electrical components.

The illustration in FIG. 1 shows a rotor 1 and essential elements of the pod 2 of a wind energy installation. A hub 3 with adjustable rotor blades 4 is shown. The rotor blades 4 are rotatably supported in a bearing 5, and can be adjusted around the rotational axis 6 in the rotation direction 7. Within the hub 3, the rotor blades 4 are for example rotatable by means of an electric motor 8 and a gear set 9 respectively. Alternatively, for one rotor blade 4, a drive for several rotor blades 4 or several drives for one rotor blade 4 can be used, although these alternatives have not been shown. It is equally possible to use other types of drive as a combination of motor 8 and gear set 9, e.g. hydraulic systems, although these alternatives have also not been shown. According to FIG. 1, the electric motors 8 are fed and controlled by a converter 10. In case of emergency when voltage fails, the interim circuits of the converter 10 are supported by electric energy storage devices 11 and enable a secure positioning of the rotor blades 4 in the flag position 12 (shown as a broken line). The use of different types of rechargeable batteries and capacitors is known as an energy storage device 11.

FIG. 1 shows further components of the hub 3. These include sensor systems 13, one or more radio interfaces 14 and a central communication unit 15. Sensors systems 13 can be directly connected to controlling converters 10 and here be available to one or more adjustment systems; in the drawing this alternative design is not shown. Additional sensor systems 13 can be coupled to a central communication unit 15 for access by the central control system ZS, or have their own communication interfaces (not shown). The communication unit 15 bundles and administers the communication between the hub components and the central control system ZS. The data is transmitted via the radio interface 14. In a further design, not shown, the components can also each have their own radio interfaces. The connection 16 between the individual hub components can be achieved via cables, radio interfaces or other suitable transmission paths.

The hub is connected to a rotor shaft 17, which is shown in FIG. 1 as a horizontal hollow shaft. The shaft is rotatably supported by a bearing 18. The bearings are firmly connected to the support system 19. The rotor shaft 17 is connected to the main generator G via a gear set 20. An auxiliary generator HG is attached in the hollow shaft and generates electric power in generator or transformer mode. The electrical connection to the hub components is achieved by electric lines 21, which rotate with the rotor system 1, as does the hub 3 and the auxiliary generator HG, thus making the use of slip rings redundant. The galvanic separation is thus guaranteed.

The excitation system 22 for generating a magnetic field for the auxiliary generator HG can consist of permanent magnets or excitation windings. For sufficient energy generation for the components of the hub 3, the excitation system 22 can be a rotatably supported permanent magnet and via self-rotation can guarantee the energy supply, even when the rotor 1 is stationary. If in an alternative embodiment excitation windings are provided in the excitation system 22, electric power can be transferred via the auxiliary generator HG by means of the revolution of the magnetic field generated with the windings, by means of suitable wiring/control 23 e.g. by the central control system ZS in generator mode, or when stationary in transformer mode. Thus, even when the wind energy installation or rotor is stationary, the rotor blades can be set at an angle by means of the adjusting apparatus 9′, in order to introduce a torque into the rotor and drive the rotor.

In a favoured embodiment, the central control system ZS adopts the control of the components in the pod and in the hub 3. A decentralised control, not shown, would also be possible. The central control system ZS is bi-directionally connected via a radio interface 24 or another non cable-bound interface and the analogue interface 14 in the hub 3 to the sensor systems 13 and the motor control systems 10 in order to adjust the blades. In the design shown, a central communication unit 15 is used in the hub 3.

In FIG. 2, the electrically and electro-magnetically shielded hub 3 by means of the realisation as a Faraday cage is shown, together with the galvanic decoupling of the electrical components. The protection according to the invention against overvoltages and their consequences is realised by a galvanic protection insulation IS of all electrical components and the embodiment of the hub 3 as a Faraday cage by means of a metallic outer shield AS.

### Production Mode

In production mode, the wind energy installation generates electrical energy and feeds this into the power grid. The central control system ZS records the characteristics of the electrical energy generated, the requirements of the grid operator, the environment conditions such as wind strength and wind direction, and operating states and any potential faults in subsystems and components. Reference is furthermore only made to the control and regulation option by adjusting the rotor blades 4. The central control system ZS records the wind speed, rotor speed and position of the blades. Depending on the regulation requirement (restriction of the speed or optimum use of the wind energy), set values are determined for the blade positions. Via the bi-directional, wireless connection 14 and 24 between the central control system ZS and the communication unit 15 in the hub 3, the sensor data (actual value, blade position) is permanently transmitted, while the set values are transmitted as required. The blade adjustment is then implemented by the converter 10. The energy for the adjustment, sensors and communication in the hub is provided by the auxiliary generator HG in the manner described.

At the same time, the central control system ZS monitors any faults or critical operational states which may occur. Error messages for faults in components in the hub are transmitted via the wireless connection 14 and 24 to the central control system ZS. When severe faults occur, an emergency brake operation can be necessary, while with other faults, a controlled braking through to standstill of the plant may be required. The wind energy installation is usually braked by adjusting the blades 4 to the flag position 12. For safety reasons, plants with two or more rotor blades 4 each have their own adjusting apparatus, and when a system fails, the other blades 4 can be brought into the flag position 12 and can thus bring the plant to a standstill or at least protect it against overpressure.

### Emergency Operation

If the severe fault is the failure of the mains voltage, the plant must be braked to a standstill immediately. If the central control system ZS and the excitation of the auxiliary generator HG is supported by the emergency energy storage device (not drawn), the central control system ZS can detect the failure of the mains voltage and allow the blade adjustment in the hub 3 to be implemented by specifying a set value of the blade position in the flag position 12.

If the excitation system 22 of the auxiliary generator HG is not supported by an emergency energy storage device, or if the auxiliary generator HG itself fails due to a defect in the excitation system 22 or in the auxiliary generator HG, the failure of the energy supply is registered in the hub 3. In this case, an emergency adjustment of the rotor blades 4 into the flag position 12 is conducted by the converter 10 using the local emergency energy storage device 11. If the wireless communication 14 and/or 24 fails, this is also detected in the hub 3 (e.g. by a communication device 15), and an emergency adjustment into the flag position 12 is automatically conducted by the converter 10.

### LIST OF REFERENCE NUMERALS

1 Rotor
2 Pod
3 Hub
4 Rotor blades
5 Bearing
6 Rotational axis
7 Rotation direction
8 Electric motor
9 Gear set
9′ Adjusting apparatus
10 Converter
11 Energy storage device
12 Flag position
13 Sensor systems
14 Radio interface
15 Communication unit
16 Connection
17 Rotor shaft
18 Bearing
19 Support system
20 Gear set
21 Electric lines
22 Excitation system
23 Wiring/control
24 Radio interface
ZS Central control system
G Main generator
HG Auxiliary generator
IS Galvanic protection insulation
AS Outer shield

1. A wind energy installation with a rotor which is rotatably supported on a pod, which comprises a hub, wherein the rotor comprises at least one adjusting apparatus which can be electrically driven and serves to adjust the pitch angle of at least one rotor blade which is affixable or affixed to the hub, and which is connected to a generator rotor which together with a stator forms a generator for supplying power to the adjusting apparatus, wherein the stator is installed and designed in such a manner that it can be used to generate a rotating magnetic field with respect to the generator rotor which is at a standstill relative to the pod.

2. A wind energy installation according to claim 1, wherein the rotating magnetic field can be realised by means of lines through which current can flow in the form of windings on the stator, wherein the lines are arranged in such a manner that when alternating or three-phase current is applied, they generate a rotating magnetic field.

3. A wind energy installation according to claim 1, wherein the rotating magnetic field can be realised by means of at least one rotatably arranged, motor driven permanent magnet.

4. A wind energy installation according to claim 1 wherein the stator is designed in such a manner that the rotational speed of the rotating magnetic field can be adjusted.

5. A wind energy installation according to claim 2 wherein the wind energy installation comprises a device for protecting the lines against overvoltage.

6. A wind energy installation according to claim 1, wherein a galvanic separation of the current-bearing parts of the adjusting apparatus is implemented with respect to the rotor.

7. A wind energy installation according to claim 1, wherein it comprises a central control system (ZS) which is not arranged on the rotor, and the adjusting apparatus is installed in order to receive and process wirelessly transmitted signals, wherein the wind energy installation comprises at least one signal transmission unit for the wireless transmission of signals from the central control system to the adjusting apparatus.

8. A wind energy installation according to claim 1, wherein the hub is designed as a Faraday cage.

9. A wind energy installation according to claim 1, wherein an emergency energy supply device is arranged in the pod and/or the hub.

10. A method for generating electric energy from wind energy by means of a wind energy installation with a rotor including rotor blades which are driven by wind energy, the pitch angles of which are adjustable by means of at least one adjusting apparatus which can be electrically driven in order to influence the rotational speed of the rotor, wherein a rotor generator is connected to the rotor, and the rotor generator forms a generator together with a stator, and wherein a magnetic field which rotates with respect to the rotor generator is produced by the stator, which by interaction with the generator rotor, which is stationary with respect to the pod, induces a current flow in the generator rotor in order to operate the adjusting apparatus.

11. A method for generating electric energy according to claim 10, wherein the rotating magnetic field is realised by applying alternating or three-phase current to lines in the form of windings on the stator.

12. A method for generating electric energy according to claim 10, wherein the rotating magnetic field is realised by at least one rotatably arranged, motor driven permanent magnet.

13. A method for generating electric energy according to claim 10, wherein the rotational speed of the rotating magnetic field is changed during the rotation.

14. A method for generating electric energy according to claim 10, wherein signals for operating the adjusting apparatus are transmitted to it in a wireless manner.

15. A method for generating electric energy according to claim 10, wherein the rotating magnetic field is generated when the rotor is stationary in order to induce a current for operating the adjusting apparatus.
